(19) United States
(12) Patent Application Publication
(10) Pub. No.: US 2021/0175999 A1
(43) Pub. Date: Jun. 10, 2021

(54) Identifying an MCS and CQI Table

(71) Applicant: Telefonaktiebolaget LM Ericsson (publ), Stockholm (SE)

(72) Inventors: Kittipong KITTICHOKECHAI, JÄRFÄLLA (SE); Alexey SHAPIN, LULEÅ (SE); Gustav WIKSTRÖM, TÄBY (SE)

(21) Appl. No.: 16/764,730

(22) PCT Filed: Nov. 7, 2018
(86) PCT No.: PCT/EP2018/080524

§ 371 Date: May 15, 2020

Related U.S. Application Data
(60) Provisional application No. 62/588,028, filed on Nov. 17, 2017.

(51) Int. Cl. H04L 1/00; H04W 8/24

(52) U.S. Cl. CPC H04L 1/0018; H04L 1/0003; H04W 8/24; H04L 1/0016; H04L 1/0009

(57) ABSTRACT

According to certain embodiments, a method performed by a wireless device comprises receiving an indication corresponding to a communication service and identifying a modulation and coding scheme (MCS) table and/or channel quality indicator (CQI) table from a plurality of defined MCS and/or CQI tables based on the received indication. According to certain embodiments, a method performed by a network node comprises determining a communication service associated to a wireless device and sending the wireless device an indication corresponding to the communication service. The indication enables the wireless device to identify an MCS and/or CQI table from a plurality of defined MCS and/or CQI tables.

### TECHNICAL FIELD

Certain embodiments of the present disclosure relate, in general, to wireless communications. More particularly, certain embodiments of the present disclosure relate to identifying a modulation and coding scheme (MCS) table and a channel quality indicator (CQI) table.

### BACKGROUND

Cellular wireless systems include network nodes that communicate with wireless devices over a wireless interface. Examples of cellular wireless systems include those specified in 3rd Generation Partnership Project (3GPP) standards, such as Long Term Evolution (LTE) and New Radio (NR). Examples of network nodes include base stations, such as Evolved Universal Terrestrial Radio Access Network nodeBs (eNBs) and base stations in NR (gNBs). Examples of wireless devices include terminals and user equipment (UE). The network nodes and wireless communicate to each other using MCSs that are set based on some channel quality information. CQI and MCS tables may be referred to by the wireless device for determining a CQI report and by the network node (eNB/gNB) for scheduling.

LTE is designed based mainly on enhanced Mobile Broad Band (eMBB) traffic type. The CQI report in the current LTE system corresponds to 10% target block error rate (BLER). The CQI and MCS tables in LTE, see for example 3GPP TS 36.213 V14.4.0 (2017 September), are also designed based on this 10% target BLER. This target BLER is not sufficient for new services or use cases requiring ultra-high reliability such as Ultra-Reliable Low Latency Communication (URLLC).

### SUMMARY

There currently exist certain challenge(s). Multiple target BLER may be available for high reliability or low latency communication services, for example URLLC. When multiple separate CQI tables and/or MCS tables are defined including a default one for eMBB, it is important to specify configuration of these tables and determine how the tables can be identified and ultimately enable a wireless device to select appropriate MCS and/or CQI values for a determined communication service from the defined tables.

For example, when multiple CQI/MCS tables are specified, methods are required to configure the usage of these tables in order for the system to operate properly and efficiently.

Certain aspects of the present disclosure and their embodiments may provide solutions to these or other challenges. Certain embodiments of the present disclosure provide new methods for configuring the use of MCS and CQI tables when multiple tables exist. For example, certain embodiments provide methods for configuring the use of MCS and QCI tables based on bit field in the downlink control information (DCI), DCI type, and/or configured target BLER. Some embodiments use CQI/MCS tables and BLER target capabilities indication by a wireless device.

According to certain embodiments, a method performed by a wireless device comprises receiving an indication corresponding to a communication service and identifying an MCS and/or CQI table from a plurality of defined MCS and/or CQI tables based on the received indication. This provides the advantage that different MCS and CQI tables may be defined and a UE separately controlled by the network to support specific communication services with varying BLER requirements.

According to certain embodiments, a wireless device comprises power supply circuitry and processing circuitry. The power supply circuitry is configured to supply power to the wireless device. The processing circuitry is configured to receive an indication corresponding to a communication service and identify an MCS and/or CQI table from a plurality of defined MCS and/or CQI tables, based on the received indication.

The above-described wireless device and/or method performed by a wireless device may include or be configured to support one or more additional features, such as any of the following features:

In certain embodiments, the communication service corresponds to a service with a high reliability requirement and/or a low latency requirement.

In certain embodiments, the received indication comprises a configured mode. For example, in certain embodiments, the configured mode corresponds to a mode having a low target BLER, a mode having a high reliability requirement, and/or a mode having a low latency requirement.

In certain embodiments, a target BLER is implicitly selected by the wireless device from all possible BLER operational levels according to gNb or HARQ-related parameters and/or UE capabilities.

In certain embodiments, the method/wireless device sends information to the network that indicates capabilities of the wireless device. The indicated capabilities comprise target BLER capabilities, MCS table capabilities, and/or CQI table capabilities of the wireless device. In some embodiments, the capabilities are indicated implicitly based on service capabilities. In some embodiments, the capabilities are indicated using explicit signalling to the network.

In certain embodiments, a target BLER is obtained by the wireless device based on receiving the indication corresponding to the communication service, and the MCS and/or CQI table is identified based on the target BLER.

In certain embodiments, the indication corresponding to the communication service is received via RRC signalling.

In certain embodiments, the identified table is an MCS table and the method/wireless device selects a modulation and coding scheme from the identified table.

In certain embodiments, the identified table is a CQI table and the method/wireless device selects a channel quality indication from the identified table.

In certain embodiments, a first MCS and/or first CQI table of the plurality of MCS and/or CQI tables corresponds to a first BLER and a second MCS and/or second CQI table of the plurality of MCS and/or CQI tables corresponds to a second BLER. The first BLER is different to the second BLER.

In certain embodiments, identifying the MCS and/or CQI table comprises determining to use only one CQI table when the wireless device is configured according to a pre-defined mode having a low target BLER.

In certain embodiments, the indication corresponding to the communication service is received via DCI. In certain embodiments, identifying the MCS and/or CQI table comprises identifying at least one MCS table and at least one CQI table based on the same bit field in DCI. In other embodiments, identifying the MCS and/or CQI table comprises identifying at least one MCS table and at least one CQI table based on different bit fields in DCI. In certain embodiments, the DCI has a DCI format, which one of a plurality of target BLERs to use is determined based on the DCI format, and the MCS and/or CQI table is identified based on the target BLER.

In certain embodiments, identifying the MCS and/or CQI table comprises identifying a CQI table that corresponds to a first target BLER and an MCS table that corresponds to a second target BLER.

In certain embodiments, the identified MCS and/or CQI table is used during the communication service.

According to certain embodiments, a method performed by a network node comprises determining a communication service associated to a wireless device and sending the wireless device an indication corresponding to the communication service. The indication enables the wireless device to identify an MCS and/or CQI table from a plurality of defined MCS and/or CQI tables.

According to certain embodiments, a network node comprises power supply circuitry and processing circuitry. The power supply circuitry is configured to supply power to the network node. The processing circuitry is configured to determine a communication service associated to a wireless device and send the wireless device an indication corresponding to the communication service. The indication enables the wireless device to identify an MCS and/or CQI table from a plurality of defined MCS and/or CQI tables.

The above-described network node and/or method performed by a network node may include or be configured to support one or more additional features, such as any of the following features:

In certain embodiments, the communication service corresponds to a service with a high reliability requirement and/or a low latency requirement.

In certain embodiments, the indication indicates a configured mode. For example, in certain embodiments, the configured mode corresponds to a mode having a low target BLER, a mode having a high reliability requirement, and/or a mode having a low latency requirement.

In certain embodiments, the indication comprises gNb or HARQ-related parameters that enable the wireless device to select a target BLER from all possible BLER operational levels.

In certain embodiments, the method and/or network node determine one or more capabilities of the wireless device and prepare the indication corresponding to the communication service based on the one or more capabilities determined for the wireless device.

In certain embodiments, the method and/or network node receive information from the wireless device that indicates capabilities of the wireless device, the indicated capabilities comprising target BLER capabilities, MCS table capabilities, and/or CQI table capabilities of the wireless device. In some embodiments, the information received from the wireless device indicates one or more service capabilities of the wireless devices, and the target BLER capabilities, MCS table capabilities, and/or CQI table capabilities of the wireless device are determined by the network node based on the service capabilities. In some embodiments, the information received from the wireless device explicitly indicates the target BLER capabilities, MCS table capabilities, and/or CQI table capabilities of the wireless device.

In certain embodiments, the indication sent to the wireless device indicates a target BLER that enables the wireless device to identify the MCS and/or CQI table.

In certain embodiments, the indication is sent to the wireless device via RRC signalling.

In certain embodiments, a first MCS and/or first CQI table of the plurality of MCS and/or CQI tables corresponds to a first BLER and a second MCS and/or second CQI table of the plurality of MCS and/or CQI tables corresponds to a second BLER. The first BLER is different to the second BLER.

In certain embodiments, the indication enables the wireless device to determine to use only one CQI table when the wireless device is configured according to a pre-defined mode having a low target BLER.

In certain embodiments, the indication is sent to the wireless device via DCI. In some embodiments, the indication enables the wireless device to identify at least one MCS table and at least one CQI table based on the same bit field in DCI. In other embodiments, the indication enables the wireless device to identify at least one MCS table and at least one CQI table based on different bit fields in DCI. In some embodiments, the DCI has a DCI format, and the DCI format enables the wireless device to determine which one of a plurality of target BLERs to use, thereby enabling the wireless device to identify the MCS and/or CQI table based on the target BLER.

In certain embodiments, the indication enables the wireless device to identify a CQI table that corresponds to a first target BLER and an MCS table that corresponds to a second target BLER.

In certain embodiments the method/network node communicates with the wireless device via the communication session in which the wireless device uses the identified MCS and/or CQI table.

Certain embodiments may provide one or more of the following technical advantage(s). For example, certain embodiments provide methods for configurations of MCS tables to be used for high reliability services such as URLLC. As another example, certain embodiments provide methods that are suitable for general configuration of systems with multiple MCS and CQI tables.

### BRIEF DESCRIPTION

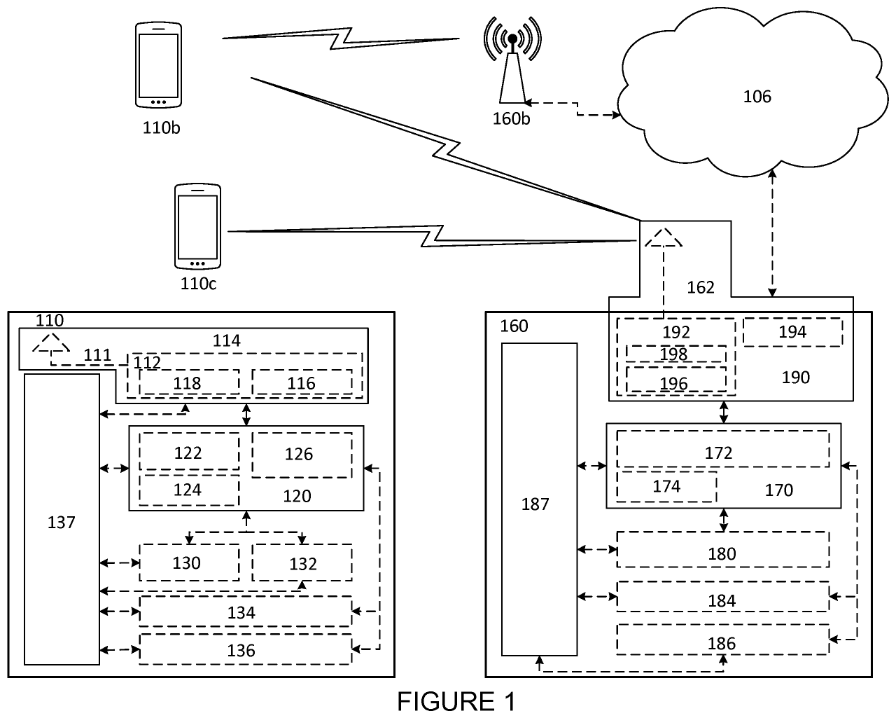

FIG. 1 illustrates an example of a wireless network, in accordance with some embodiments.

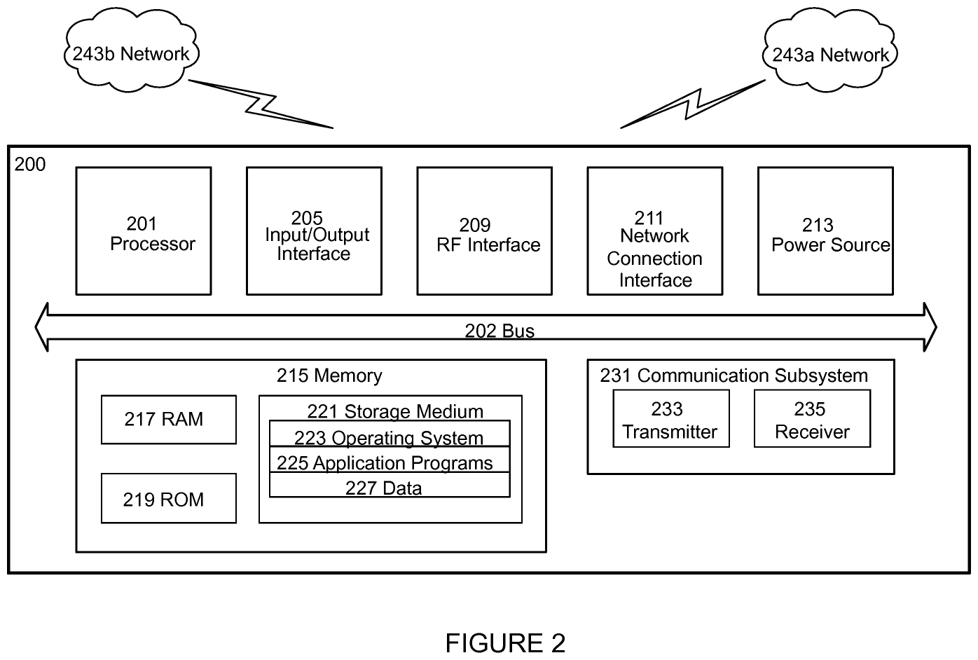

FIG. 2 illustrates an example of User Equipment, in accordance with some embodiments.

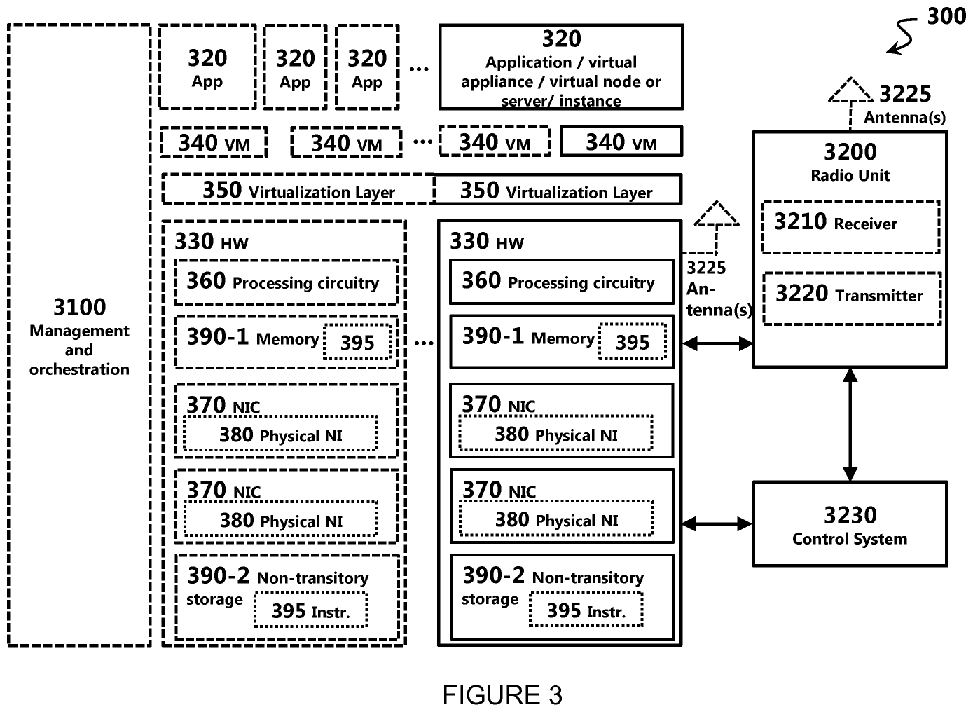

FIG. 3 illustrates an example of a virtualization environment, in accordance with some embodiments.

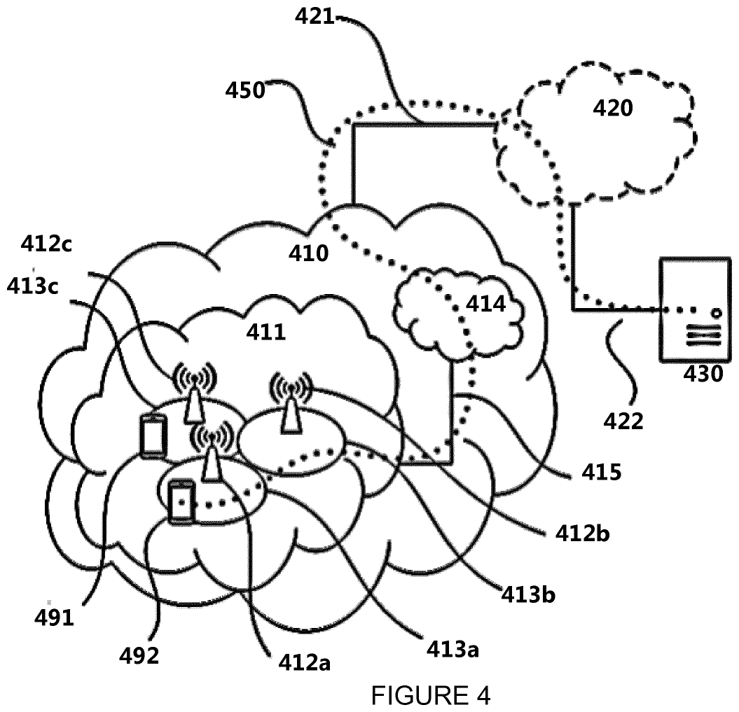

FIG. 4 illustrates an example of a telecommunication network connected via an intermediate network to a host computer, in accordance with some embodiments.

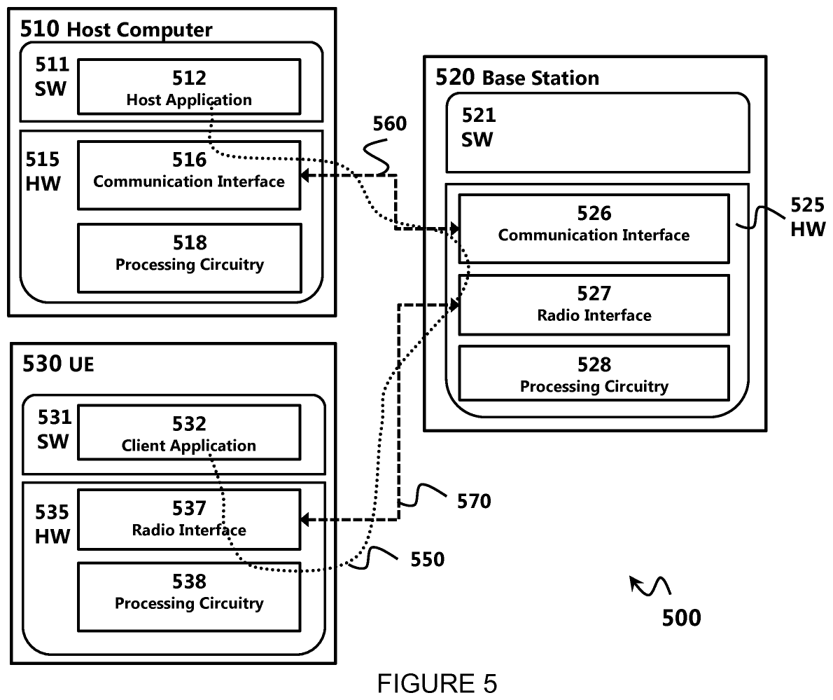

FIG. 5 illustrates an example of a host computer communicating via a base station with a user equipment over a partially wireless connection, in accordance with some embodiments.

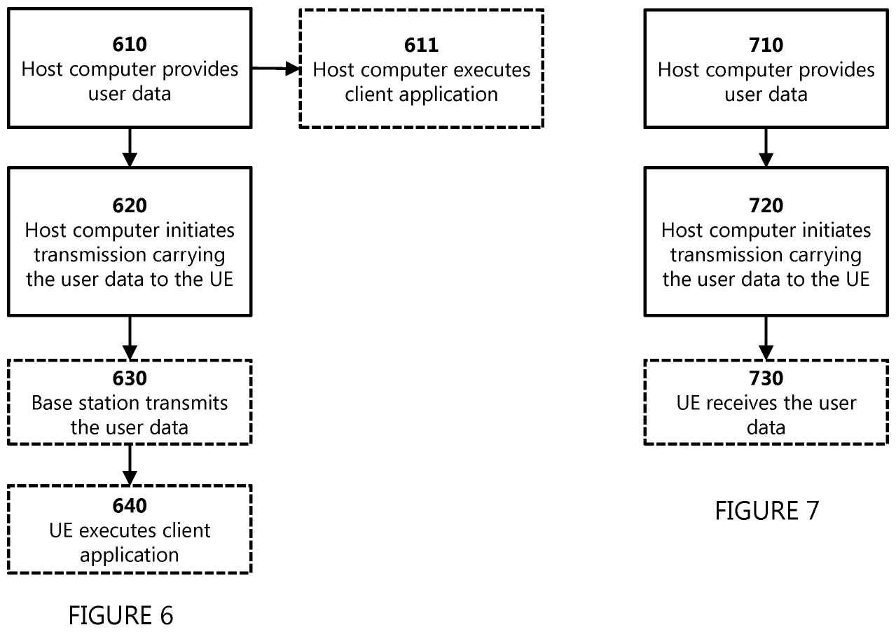

FIG. 6 illustrates an example of methods implemented in a communication system including a host computer, a base station and a user equipment, in accordance with some embodiments.

FIG. 7 illustrates an example of methods implemented in a communication system including a host computer, a base station and a user equipment, in accordance with some embodiments.

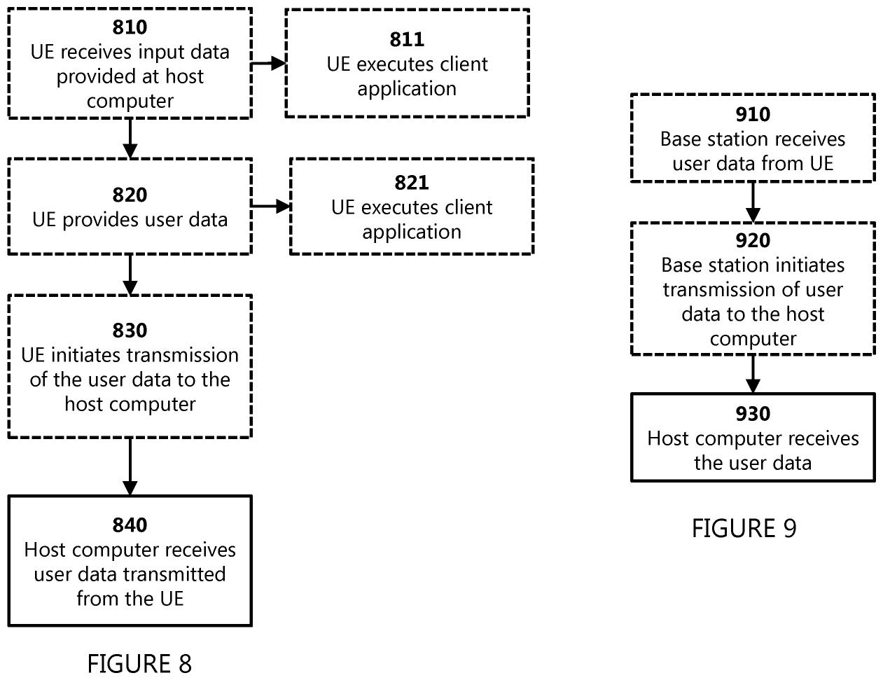

FIG. 8 illustrates an example of methods implemented in a communication system including a host computer, a base station and a user equipment, in accordance with some embodiments.

FIG. 9 illustrates an example of methods implemented in a communication system including a host computer, a base station and a user equipment, in accordance with some embodiments.

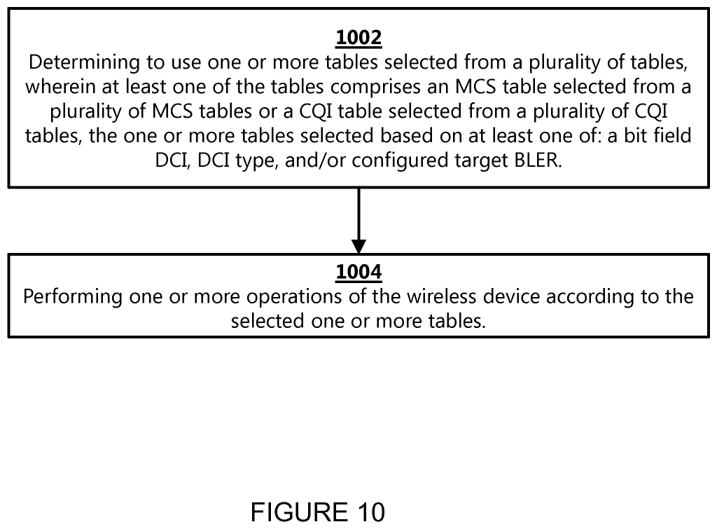

FIG. 10 illustrates an example of methods in accordance with some embodiments.

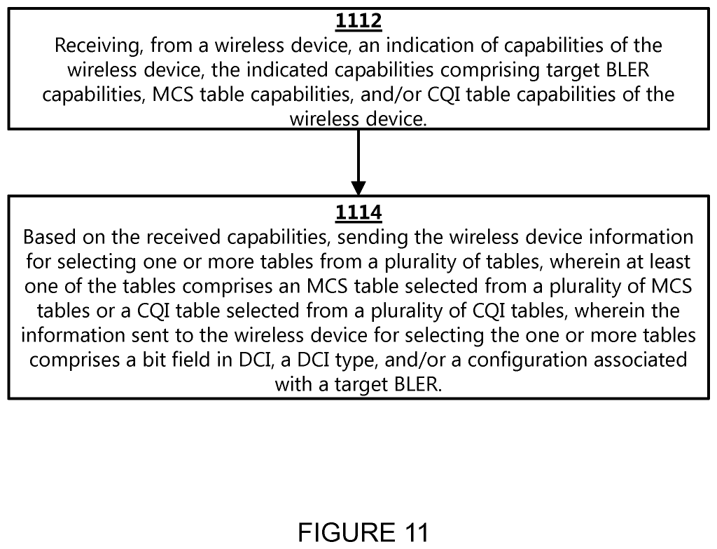

FIG. 11 illustrates an example of methods in accordance with some embodiments.

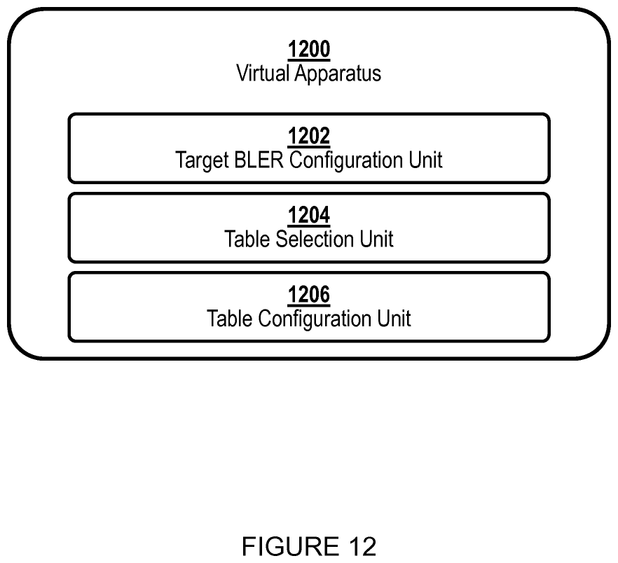

FIG. 12 illustrates an example of a virtualization apparatus, in accordance with some embodiments.

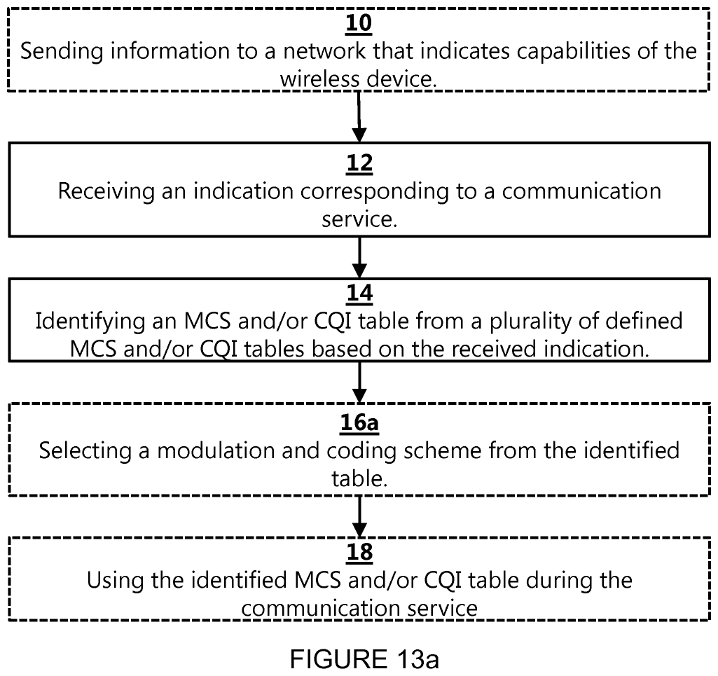

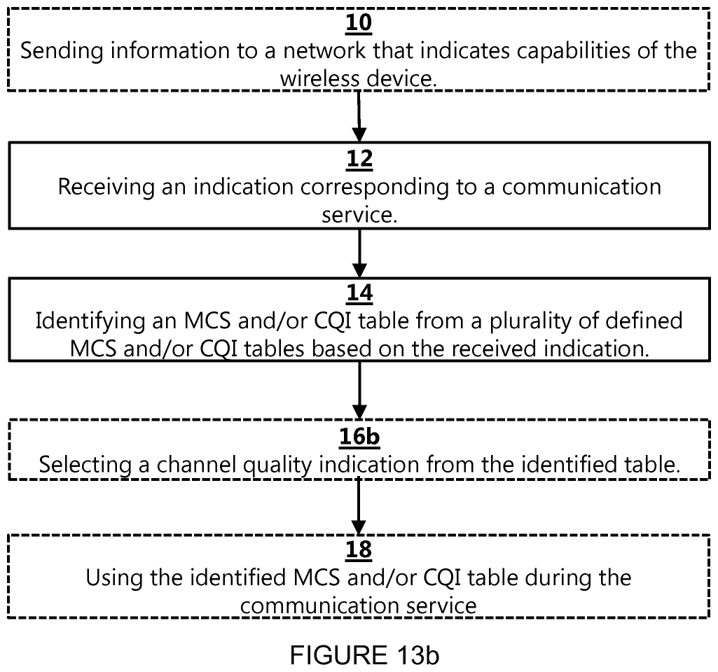

FIGS. 13a and 13b each illustrate an example of a method that may be performed by a wireless device in accordance with some embodiments.

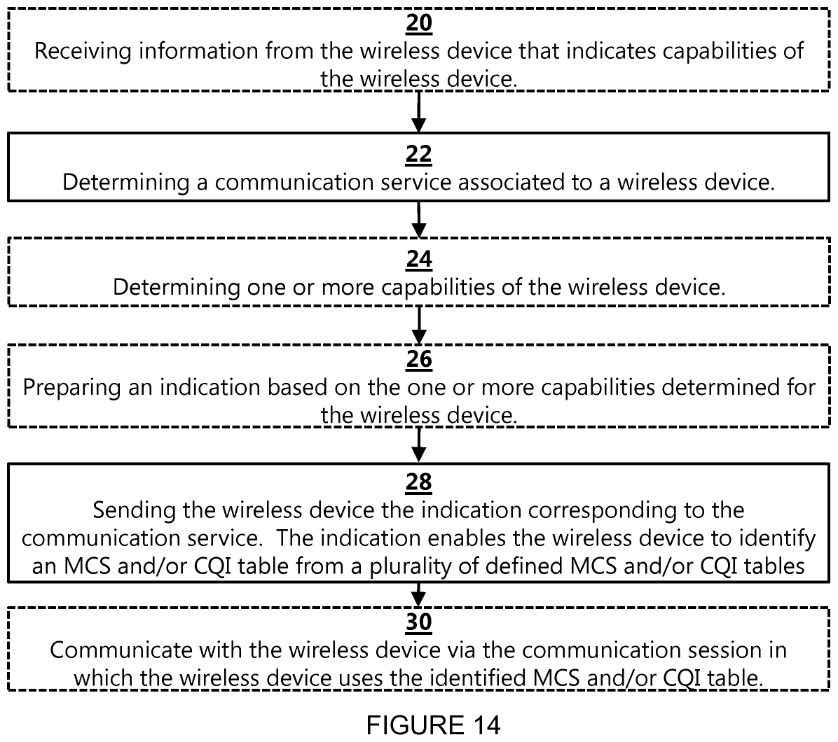

FIG. 14 illustrates an example of a method that may be performed by a network node in accordance with some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In 3GPP new radio (NR), two new target block error rates (BLER) are supported for ultra-reliable low latency communication (URLLC). In the following description, these target BLERs have been denoted as BLER1 and BLER2. The default BLER operation level of 10% is denoted by BLER0. There can exist separate Channel Quality Indicator (CQI) and modulation and coding scheme (MCS) tables corresponding to each of these targets.

Examples of BLER1 and BLER2 can be 10\hat{ }-3 and 10\hat{ }-5 corresponding to target BLER when one retransmission is allowed and when only single transmission is allowed to reach the overall target of 10\hat{ }-5.

According to certain embodiments, the wireless device can indicate its configuration/capabilities to the network. For example, the wireless device can indicate to the network the wireless device's BLER targets and MCS/CQI tables capabilities. The capabilities can be indicated implicitly (by service capabilities) or explicitly (by signaling). The ability to indicate such capabilities to the network may be critical in certain situations, particularly if the wireless device does not support all possible MCS/CQI tables or target BLERs defined in a system. The present disclosure introduces this possibility.

Several possibilities exist for configuring MCS and CQI tables. For example, in one embodiment, radio resource control (RRC) is used to configure the wireless device with a BLER operation level (such as a BLER operation level selected from BLER0, BLER1, BLER2). The wireless device then uses the MCS and CQI table corresponding to that BLER level.

As another example, in one embodiment, target BLER is implicitly picked by the wireless device from all possible BLER operational levels according to eNB/gNB or hybrid automatic repeat request (HARQ)-related parameters and/or wireless device capabilities. Examples of parameters or capabilities that can be used by the wireless device to pick the target BLER include maximum allowed number of HARQ transmissions, sub-carrier spacing (numerology), transmission time interval, mini-slot duration, URLLC capabilities, etc. Consecutively, the wireless device selects CQI/MCS table to operate.

As another example, in one embodiment, the wireless device is radio resource control (RRC) protocol configured with “low target BLER mode” or “URLLC mode” and uses two CQI and two MCS tables corresponding to BLER1 and BLER2. A further option would be to use a bit in the downlink control information (DCI) to indicate which CQI table should be used for polled CQI. In addition, or in the alternative, a further option would be to configure the use of only one CQI table when the wireless device is RRC configured with “low target BLER mode” or “URLLC mode.” This can be applied, for example, for periodic channel state information (CSI) operation.

As yet another example, in one embodiment, when there is a DCI bit indicating which CQI table to use in the polled CQI operation, the same indication bit is also used to indicate the MCS table for eNB/gNB scheduling. That is, there can be no additional MCS table indication bit in the DCI corresponding to the scheduled transmission.

As another example, in another embodiment, when there is a DCI bit indicating which CQI table to use in the polled CQI operation (e.g., to use CQI table corresponding to BLER1), eNB/gNB can decide to schedule with MCS from another MCS table (table corresponding to BLER2). An MCS table indication bit is used in the DCI to indicate which MCS table is used for scheduling.

In another embodiment, the wireless device is configured with one BLER target [either BLER1 or BLER2] connected to specific DCI format, e.g., fallback DCI or compact DCI format. When receiving the specific DCI, it uses MCS and CQI tables corresponding to the one low BLER.

In yet another embodiment, the wireless device is configured with two BLER targets connected to specific DCI format. When receiving the specific DCI, it uses MCS and CQI tables corresponding to one low BLER [BLER1 or BLER2] as indicated by a bit in the DCI.

Although the subject matter described herein may be implemented in any appropriate type of system using any suitable components, the embodiments disclosed herein are described in relation to a wireless network, such as the example wireless network illustrated in FIG. 1. For simplicity, the wireless network of FIG. 1 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 1, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 1 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network, and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

FIG. 2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 2, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 2 is a UE, the components discussed herein are equally applicable to a wireless device, and vice-versa.

In FIG. 2, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 2, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 2, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 2, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

FIG. 3 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

With reference to FIG. 4, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 4 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

Example implementations, in accordance with an embodiment, of the UE, base station and host computer discussed in the preceding paragraphs will now be described with reference to FIG. 5. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 5, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

FIG. 6 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 6 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 7 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 7 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

FIG. 8 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 8 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 9 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

FIG. 10 depicts a method that be performed by wireless device, such as wireless device 110 or 200. In accordance with particular embodiments, the method begins at step 1002 with determining to use one or more tables selected from a plurality of tables. At least one of the tables comprises an MCS table selected from a plurality of MCS tables or a CQI table selected from a plurality of CQI tables. The one or more tables are selected based on at least one of a bit field DCI, DCI type, and/or configured target BLER. The method continues to step 1004 with performing one or more operations of the wireless device according to the selected one or more tables. In some embodiments, examples of such operations may include polled CQI operations and/or eNB/gNB scheduling.

FIG. 11 depicts a method that may be performed by a network node, such as network node 160. In accordance with particular embodiments, the method begins at step 1112 with receiving, from a wireless device, an indication of capabilities of the wireless device. The indicated capabilities comprise target BLER capabilities, MCS table capabilities, and/or CQI table capabilities of the wireless device. The method proceeds to step 1114 with sending the wireless device information for selecting one or more tables from a plurality of tables. At least one of the tables comprises an MCS table selected from a plurality of MCS tables or a CQI table selected from a plurality of CQI tables. The information sent to the wireless device for selecting the one or more tables is based on the received capabilities and comprises a bit field in DCI, a DCI type, and/or a configuration associated with a target BLER. In other embodiments, step 1112 may be optional. For example, rather than having to receive the wireless device capabilities from the wireless device, the network node may determine the wireless device capabilities based on stored information or based on a pre-defined rule (such as rule that assumes the wireless device supports all of the capabilities defined for the system, e.g., unless indicated otherwise by the wireless device).

FIG. 12 illustrates a schematic block diagram of an apparatus 1200 in a wireless network (for example, the wireless network shown in FIG. 1). The apparatus may be implemented in a wireless device or network node (e.g., wireless device 110 or network node 160 shown in FIG. 1). Apparatus 1200 is operable to carry out the example method described with reference to FIG. 10, 11, 13a, 13b, or 14, and possibly any other processes or methods disclosed herein. It is also to be understood that each of the methods described in FIGS. 10, 11, 13a, 13b, and 14 is not necessarily carried out solely by apparatus 1200. At least some operations of the method can be performed by one or more other entities.

Virtual Apparatus 1200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Target BLER Configuration Unit 1202, Table Selection Unit 1204, Table Configuration Unit 1206, and any other suitable units of apparatus 1200 to perform corresponding functions according one or more embodiments of the present disclosure.

As illustrated in FIG. 12, apparatus 1200 includes Target BLER Configuration Unit 1202, Table Selection Unit 1204, and Table Configuration Unit 1206. In certain embodiments, Target BLER Configuration Unit 1202 is operable to configure a target BLER for the wireless device. As an example, in certain embodiments, the Target BLER Configuration Unit 1202 enables a mode of operation that corresponds to a target BLER selected from BLER0, BLER1, and BLER2. Table Selection Unit 1204 selects a QCI table and/or MCS table from a plurality of QCI/MCS tables. In certain embodiments, the selection may be based at least in part on the target BLER configured by Target BLER Configuration Unit 1202. Table Configuration Unit 1206 facilitates configuring the wireless device to perform operations according to the table selected by Table Selection Unit 1204. For example, in certain embodiments operating in a wireless device, Table Configuration Unit 1206 applies the table selected by Table Selection Unit 1204. As another example, in certain embodiments operating in a network node, Table Configuration Unit 1206 generates information to send to the wireless device (such as a DCI field or DCI type) that causes the wireless device to apply the table selected by Table Selection Unit 1204.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

FIGS. 13a and 13b each illustrate an example of a method that may be performed by a wireless device, such as wireless device 110 described above, in accordance with some embodiments. In some embodiments, the method may begin at step 10 with sending an indication to the network (e.g., via network node 160) that indicates capabilities of the wireless device. Examples of wireless device capabilities that may be sent in step 10 include target BLER capabilities, MCS table capabilities, and/or CQI table capabilities of the wireless device. The capabilities may be indicated implicitly, for example, based on service capabilities, or may be indicated explicitly.

At step 12, the method receives an indication corresponding to a communication service. As an example, the indication may be received from a network node, e.g., via RRC or DCI signalling, and may enable the wireless device to identify an MCS and/or CQI table from a plurality of defined MCS and/or CQI tables. As described with respect to FIG. 14, in certain embodiments, the indication may be prepared by the network node based at least in part on the indication of wireless device capabilities that the wireless device sent to the network in step 10.

In certain embodiments, the indication received in step 12 corresponds to a communication service with a high reliability requirement and/or a low latency requirement. In certain embodiments, the received indication comprises a configured mode, such as a mode having a low target BLER, a mode having a high reliability requirement, and/or a mode having a low latency requirement. The wireless device may use the indication of the mode to identify an MCS and/or CQI table.

At step 14, the method identifies an MCS and/or CQI table from a plurality of defined MCS and/or CQI tables based on the indication received at step 12. The MCS and/or CQI table may be identified according to any of the examples set forth in this disclosure, such as the examples described in the summary section, the examples described in the Group A embodiments, etc.

In certain embodiments, the method proceeds to step 16 with selecting information from the identified table(s). FIG. 13a illustrates an example in which at least one of the tables identified in step 14 includes an MCS table, and the method selects a modulation and coding scheme from the identified MCS table at step 16a. FIG. 13b illustrates an example in which at least one of the tables identified in step 14 includes a CQI table, and the method selects a channel quality indication from the identified CQI table at step 16b.

At step 18, the method may use the identified MCS and/or CQI table during the communication service. For example, the method may use the MCS selected in step 16a or the CQI identified in step 16b when performing operations associated with the communication service.

FIG. 14 illustrates an example of a method that may be performed by a network node, such as network node 160 describe above, in accordance with some embodiments. In some embodiments, the method may begin at step 20 with receiving information from a wireless device. The information indicates capabilities of the wireless device. Examples of such capabilities include target BLER capabilities, MCS table capabilities, and/or CQI table capabilities of the wireless device. The wireless device may indicate the capabilities implicitly, for example, based on service capabilities, or explicitly.

At step 22, the method determines a communication service associated to the wireless device. As further described below, the network node may then enable the wireless device to identify an MCS and/or CQI table such that the wireless device can use information obtained from the identified table when performing operations associated with the communication session.

At step 24, in some embodiments, the method determines one or more capabilities of the wireless device. In some embodiments, the capabilities may be determined at least in part based on the information received in step 20. As an example, in some embodiments, information indicating service capabilities of the wireless device may be received in step 20, and that information may be used to determine the target BLER capabilities, MCS table capabilities, and/or CQI table capabilities of the wireless device at step 24. As another example, in some embodiments, the information received in step 20 may explicitly include target BLER capabilities, MCS table capabilities, and/or CQI table capabilities and the method may determine to consider one or more of these capabilities when preparing the indication described below with respect to step 26. In addition, or in the alternative, in some embodiments, capabilities of the wireless device may be determined at least in part from information stored by the network node or obtained from another network node.

In certain embodiments, the method further comprises preparing an indication corresponding to the communication service at step 26. The indication enables the wireless device to identify an MCS and/or CQI table from a plurality of defined MCS and/or CQI tables. In some embodiments, the indication may be prepared based on the one or more capabilities determined for the wireless device at step 24.

At step 28, the method sends the wireless device the indication corresponding to the communication service (e.g., the indication prepared in step 26). The indication enables the wireless device to identify an MCS and/or CQI table from a plurality of defined MCS and/or CQI tables. As further described above and in the Group B embodiments, in certain embodiments, the indication may be sent in RRC signalling or DCI signalling.

### EXAMPLES

### Group A Examples

Group A, Example A. A method performed by a wireless device, the method comprising:
   determining to use one or more tables selected from a plurality of tables, wherein at least one of the tables comprises a Modulation Coding Scheme (MCS) table selected from a plurality of MCS tables or a Channel Quality Indicator (CQI) table selected from a plurality of CQI tables, the one or more tables selected based on at least one of: a bit field in Downlink Control Information (DCI), DCI type, and/or configured target Block Error Rate (BLER); and
   performing one or more operations of the wireless device according to the selected one or more tables.
Group A, Example B. The method of the previous example further comprising:
   sending an indication to the network that indicates capabilities of the wireless device, the indicated capabilities comprising target BLER capabilities, MCS table capabilities, and/or CQI table capabilities of the wireless device.
Group A, Example C. The method of the previous example, wherein the capabilities are indicated implicitly based on service capabilities.
Group A, Example D. The method of Group A, Example B, wherein the capabilities are indicated using explicit signaling to the network.
Group A, Example E. The method of any of Group A, Examples B-D, wherein the sending of the capabilities is performed in response to determining that the wireless device does not support all possible target BLER capabilities, MCS table capabilities, and/or CQI table capabilities defined in the system.
Group A, Example F. The method of any of the previous examples, further comprising configuring the wireless device with one of a plurality of target BLERs and selecting the table that corresponds to the configured target BLER.
Group A, Example G. The method of Group A, Example F, further comprising determining which one of the plurality of target BLERs to configure based on Radio Resource Control (RRC) signaling from the network.
Group A, Example H. The method of Group A, Example F, further comprising determining which one of the plurality of target BLERs to configure based on one or more of: maximum allowed number of Hybrid Automatic Repeat Request (HARQ) transmissions, sub-carrier spacing (numerology), transmission time interval, mini-slot duration, and/or Ultra-Reliable Low Latency Communication (URLLC) capabilities.
Group A, Example I. The method of any of the previous examples, wherein determining the one or more tables further comprises configuring a first CQI table corresponding to a first target BLER, a second CQI table corresponding to a second target BLER, a first MCS table corresponding to the first target BLER, and a second MCS table corresponding to the second target BLER when the wireless device is configured according to a pre-defined mode having a low target BLER.
Group A, Example J. The method of any of Group A, Examples A-H, wherein determining the one or more tables further comprises configuring only one CQI table when the wireless device is configured according to a pre-defined mode having a low target BLER.
Group A, Example K. The method of Group A, Example J, wherein the wireless device uses only the one CQI table when configured for periodic CSI operation.
Group A, Example L. The method of any of the previous examples, wherein the determining of which of the plurality of CQI tables to use is based on a bit field in DCI indicating which CQI table to use in polled CQI operation, and wherein the determining of which of the plurality of MCS tables to use is based on the same bit field in DCI indicating which CQI table to use in polled CQI operation.
Group A, Example M. The method of any of the previous examples, wherein the determining of which of the plurality of CQI tables to use is based on a first bit field in DCI indicating which CQI table to use in polled CQI operation, and wherein the determining of which of the plurality of MCS tables to use is based a second bit field in DCI indicating which MCS table to use for network node scheduling.
Group A, Example N. The method of any of the previous examples, wherein the CQI table corresponds to a first target BLER and the MCS table corresponds to a second target BLER.
Group A, Example O. The method of any of the previous examples, further comprising determining which one of a plurality of target BLERs to use based on DCI format (e.g., fallback DCI or compact DCI) and using MCS and CQI tables corresponding to the target BLER.
Group A, Example P. The method of any of the previous examples, wherein the wireless device is configured with a first BLER target associated with a first DCI format and a second BLER target associated with a second DCI format and wherein:
   when receiving the first DCI format, the wireless device uses tables corresponding to the first BLER target; and
   when receiving the second DCI format, the wireless device uses tables corresponding to the second BLER target.
Group A, Example Q. The method of any of the previous examples, further comprising:
   providing user data; and
   forwarding the user data to a host computer via the transmission to the base station.

### Group B Examples

Group B, Example A. A method performed by a base station, the method comprising:
   receiving, from a wireless device, an indication of capabilities of the wireless device, the indicated capabilities comprising target BLER capabilities, MCS table capabilities, and/or CQI table capabilities of the wireless device;
   based on the received capabilities, sending the wireless device information for selecting one or more tables from a plurality of tables, wherein at least one of the tables comprises an MCS table selected from a plurality of MCS tables or a CQI table selected from a plurality of CQI tables, wherein the information sent to the wireless device for selecting the one or more tables comprises a bit field in DCI, a DCI type, and/or a configuration associated with a target BLER.
Group B, Example B. The method of the previous example, wherein the capabilities are received via an implicit indication based on service capabilities.
Group B, Example C. The method of Group B, Example A, wherein the capabilities are received via explicit signaling from the wireless device.
Group B, Example D. The method of any of the previous examples, wherein the information for selecting the one or more tables includes a target BLER configuration based on which the wireless device is to use a table that corresponds to the target BLER.
Group B, Example E. The method of Group B, Example D, wherein the target BLER is configured via Radio Resource Control (RRC) signaling sent to the wireless device.
Group B, Example F. The method of Group B, Example D, wherein the target BLER is configured based on configuring one or more of: maximum allowed number of Hybrid Automatic Repeat Request (HARQ) transmissions, sub-carrier spacing (numerology), transmission time interval, mini-slot duration, and/or Ultra-Reliable Low Latency Communication (URLLC) capabilities.
Group B, Example G. The method of any of the previous examples, wherein the information sent to the wireless device configures the wireless device according to a pre-defined mode having a low target BLER, thereby causing the wireless device to configure a first CQI table corresponding to a first target BLER, a second CQI table corresponding to a second target BLER, a first MCS table corresponding to the first target BLER, and a second MCS table corresponding to the second target BLER.
Group B, Example H. The method of any of examples Group B, Examples A-F, wherein the information sent to the wireless device configures the wireless device according to a pre-defined mode having a low target BLER, thereby causing the wireless device to configure only one CQI table.
Group B, Example I. The method of example Group B, Examples A-F, wherein the information sent to the wireless device configures the wireless device according to a pre-defined mode having a low target BLER, thereby causing the wireless device to configure only one CQI table when configured for periodic CSI operation.
Group B, Example J. The method of any of the previous examples, wherein sending the wireless device information for selecting the one or more tables comprises sending a bit field in DCI indicating which CQI table to use in polled CQI operation, the same bit field in DCI configured to cause the wireless device to determine which of the plurality of MCS tables to use.
Group B, Example K. The method of any of the previous examples, wherein sending the wireless device information for selecting the one or more tables comprises sending a first bit field in DCI indicating which CQI table to use in polled CQI operation and a second bit field in DCI indicating which MCS table to use for network node scheduling.
Group B, Example L. The method of any of the previous examples, wherein the CQI table corresponds to a first target BLER and the MCS table corresponds to a second target BLER.
Group B, Example M. The method of any of the previous examples, further comprising configuring a DCI format (e.g., fallback DCI or compact DCI) that causes the wireless device to configure a target BLER selected from a plurality of target BLERs and to use MCS and CQI tables corresponding to the configured target BLER.
Group B, Example N. The method of any of the previous examples, further comprising:
   obtaining user data; and
   forwarding the user data to a host computer or a wireless device.

### Group C Examples

Group C, Example A. A wireless device, the wireless device comprising:
   processing circuitry configured to perform any of the steps of any of the Group A examples; and
   power supply circuitry configured to supply power to the wireless device.
Group C, Example B. A base station, the base station comprising:
   processing circuitry configured to perform any of the steps of any of the Group B examples;
   power supply circuitry configured to supply power to the wireless device.
Group C, Example C. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A examples;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
Group C, Example D. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B examples.
Group C, Example E. The communication system of the pervious example further including the base station.
Group C, Example F. The communication system of the previous 2 examples, further including the UE, wherein the UE is configured to communicate with the base station.
Group C, Example G. The communication system of the previous 3 examples, wherein:
   the processing circuitry of the host computer is configured to execute a host application, thereby providing the user data; and
   the UE comprises processing circuitry configured to execute a client application associated with the host application.
Group C, Example H. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B examples.
Group C, Example I. The method of the previous example, further comprising, at the base station, transmitting the user data.
Group C, Example J. The method of the previous 2 examples, wherein the user data is provided at the host computer by executing a host application, the method further comprising, at the UE, executing a client application associated with the host application.
Group C, Example K. A user equipment (UE) configured to communicate with a base station, the UE comprising a radio interface and processing circuitry configured to performs the of the previous 3 examples.
Group C, Example L. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A examples.
Group C, Example M. The communication system of the previous example, wherein the cellular network further includes a base station configured to communicate with the UE.
Group C, Example N. The communication system of the previous 2 examples, wherein:
   the processing circuitry of the host computer is configured to execute a host application, thereby providing the user data; and
   the UE's processing circuitry is configured to execute a client application associated with the host application.
Group C, Example O. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A examples.
Group C, Example P. The method of the previous example, further comprising at the UE, receiving the user data from the base station.
Group C, Example Q. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A examples.
Group C, Example R. The communication system of the previous example, further including the UE.
Group C, Example S. The communication system of the previous 2 examples, further including the base station, wherein the base station comprises a radio interface configured to communicate with the UE and a communication interface configured to forward to the host computer the user data carried by a transmission from the UE to the base station.
Group C, Example T. The communication system of the previous 3 examples, wherein:
   the processing circuitry of the host computer is configured to execute a host application; and
   the UE's processing circuitry is configured to execute a client application associated with the host application, thereby providing the user data.
Group C, Example U. The communication system of the previous 4 examples, wherein:
   the processing circuitry of the host computer is configured to execute a host application, thereby providing request data; and
   the UE's processing circuitry is configured to execute a client application associated with the host application, thereby providing the user data in response to the request data.
Group C, Example V. A method implemented in a communication system including a host computer, a base station and a user equipment (UE), the method comprising:
   at the host computer, receiving user data transmitted to the base station from the UE, wherein the UE performs any of the steps of any of the Group A examples.
Group C, Example W. The method of the previous example, further comprising, at the UE, providing the user data to the base station.
Group C, Example X. The method of the previous 2 examples, further comprising:
   at the UE, executing a client application, thereby providing the user data to be transmitted; and
   at the host computer, executing a host application associated with the client application.
Group C, Example Y. The method of the previous 3 examples, further comprising:
   at the UE, executing a client application; and
   at the UE, receiving input data to the client application, the input data being provided at the host computer by executing a host application associated with the client application,
   wherein the user data to be transmitted is provided by the client application in response to
Group C, Example Z. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B examples.
Group C, Example AA. The communication system of the previous example further including the base station.
Group C, Example AB. The communication system of the previous 2 examples, further including the UE, wherein the UE is configured to communicate with the base station.
Group C, Example AC. The communication system of the previous 3 examples, wherein:
   the processing circuitry of the host computer is configured to execute a host application;
   the UE is configured to execute a client application associated with the host application, thereby providing the user data to be received by the host computer.
Group C, Example AD. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A examples.
Group C, Example AE. The method of the previous example, further comprising at the base station, receiving the user data from the UE.
Group C, Example AF. The method of the previous 2 examples, further comprising at the base station, initiating a transmission of the received user data to the host computer.

1. A method performed by a wireless device for determining a modulation and coding scheme, MCS, from a plurality of MCS tables, the method comprising:
receiving (12) an indication corresponding to a target block error rate, BLER, and
identifying (14) a modulation and coding scheme, MCS, table, from the plurality of defined MCS, based on the received indication and selecting a modulation and coding scheme from the identified MCS table.

2. The method according to claim 1, wherein the indication corresponds to a service with a high reliability requirement and/or a low latency requirement.

3. (canceled)

4. The method according to claim 1, wherein the indication corresponds to:
a low target, BLER.

5. (canceled)

6. The method of claim 1, further comprising:
sending information to the network that indicates capabilities of the wireless device, the indicated capabilities comprising at least target BLER capabilities of the wireless device.

7. The method of claim 6, wherein the capabilities are indicated implicitly based on service capabilities.

8. The method of claim 6, wherein the capabilities are indicated using explicit signalling to the network.

9.-12. (canceled)

13. The method according to claim 1, wherein a first MCS table of the plurality of MCS tables corresponds to a first BLER and a second MCS table of the plurality of MCS tables corresponds to a second BLER, wherein the first BLER is different to the second BLER.

14.-19. (canceled)

20. The method of claim 7, further comprising using the identified MCS table during the communication service.

21. A wireless device, comprising:
power supply circuitry configured to supply power to the wireless device; and
processing circuitry configured to:
receive an indication corresponding to a block error rate, BLER; and
identify a modulation and coding scheme, MCS, table from a plurality of defined MCS, based on the received indication and select a modulation and coding scheme from the identified MCS table.

22. The wireless device according to claim 21, wherein the indication corresponds to a service with a high reliability requirement and/or a low latency requirement.

23. (canceled)

24. The wireless device according to claim 21, wherein the indication corresponds to:
a low target block error rate, BLER.

25. (canceled)

26. The wireless device of claim 21, the processing circuitry further configured to:
send information to the network that indicates capabilities of the wireless device, the indicated capabilities comprising at least target BLER capabilities, MCS table capabilities of the wireless device.

27. The wireless device of claim 26, wherein the capabilities are indicated implicitly based on service capabilities.

28. The wireless device of claim 26, wherein the capabilities are indicated using explicit signalling to the network.

29.-32. (canceled)

33. The wireless device according to claim 21, wherein a first MCS table of the plurality of MCS tables corresponds to a first BLER and a second MCS table of the plurality of MCS tables corresponds to a second BLER, wherein the first BLER is different to the second BLER.

34.-39. (canceled)

40. The wireless device of claim 21, further comprising using the identified MCS and/or CQI table during the communication service.

41. A method performed by a network node, the method comprising:
determining a block error rate, BLER associated to a communication service; and
sending the wireless device an indication corresponding to the BLER, wherein the indication enables the wireless device to identify a modulation and coding scheme, MCS, table from a plurality of defined MCS tables.

42. (canceled)

43. (canceled)

44. The method according to claim 41, wherein the indication corresponds to:
a low target block error rate, BLER.

45. (canceled)

46. The method according to claim 41, further comprising:
determining one or more capabilities of the wireless device; and
preparing the indication based on the one or more capabilities determined for the wireless device.

47. The method of claim 41, further comprising:
receiving information from the wireless device that indicates capabilities of the wireless device, the indicated capabilities comprising target BLER capabilities, MCS table capabilities, and/or CQI table capabilities of the wireless device.

48. The method of claim 47, wherein the information received from the wireless device indicates one or more service capabilities of the wireless devices, and wherein the target BLER capabilities, MCS table capabilities, and/or CQI table capabilities of the wireless device are determined by the network node based on the service capabilities.

49.-58. (canceled)

59. The method of claim 41, further comprising communicating (30) with the wireless device via the communication session in which the wireless device uses the identified MCS table.

60. A network node, the network node comprising:
power supply circuitry configured to supply power to the network node; and
processing circuitry configured to:
determine a block error rate, BLER associated to a communication service; and
send the wireless device an indication corresponding to the BLER, wherein the indication enables the wireless device to identify a modulation and coding scheme, MCS, table from a plurality of defined MCS tables.

61. The network node of claim 60, wherein the processing circuitry is further configured to:
determine one or more capabilities of the wireless device; and
prepare the indication based on the one or more capabilities determined for the wireless device.
